(19) United States
(12) Patent Application Publication
(10) Pub. No.: US 2025/0180136 A1
(43) Pub. Date: Jun. 5, 2025

(54) ARMATURE SYSTEM, VALVE SYSTEM, AND SOLENOID VALVE, AS WELL AS METHOD FOR PRODUCING A VALVE SYSTEM

(71) Applicant: Nass Magnet GmbH, Hannover (DE)

(72) Inventors: Dana Brockmann, Buchholz i.d.N (DE); Robin Paetz, Sehnde (DE); Dimitri Krou, Lehrte (DE); Carsten Rust, Garbsen (DE); Sebastian Westphal, Laatzen (DE); Michel Cordes, Seelze (DE); Reiner Hölscher, Seelze (DE)

(21) Appl. No.: 18/929,869

(22) Filed: Oct. 29, 2024

(30) Foreign Application Priority Data
Nov. 30, 2023 (DE) 102023133515.4

(51) Int. Cl. F16K 31/06

(52) U.S. Cl. CPC F16K 31/0655

(57) ABSTRACT

The invention relates to an armature system for a solenoid valve including a magnetic core, a magnetic armature, and a tubular armature guide for guiding the magnetic armature, wherein the armature guide is made of plastic, and the magnetic core is connected to the armature guide via a positive connection which is formed by a thermoplastic deformation of the armature guide. Furthermore, the invention provides a valve system, a solenoid valve, and a method for producing the valve system with such an armature system.

The invention relates to an armature system for a solenoid valve, a valve system, a solenoid valve, and a method for producing a valve system.

A solenoid valve is an electromechanically operated component for controlling gaseous or liquid media. It is used to open, close, mix, or divert media in an application. They are used in a wide range of applications—for example, in dishwashers, cars, irrigation systems, or for controlling compressed air or inert technical gases.

An essential component of the solenoid valve is the armature system, which comprises a magnetic core, a magnetic armature, and a tubular armature guide. While the magnetic armature is usually guided in the armature guide so that it can be moved against the pressure of an armature spring, the magnetic core, which is partially inserted into the armature guide, is fixedly connected to the armature guide. The armature guide is often made of brass or stainless steel and is pressed onto the metallic magnetic core in the region of a circumferential groove in the magnetic core.

According to DE 10 2012 011 627 A1, the armature guide is pushed over a radial taper of the magnetic core and connected to it in a pressure-tight and pressure-resistant manner by means of a press and/or adhesive connection. Furthermore, a solenoid valve is described having a coil body which is molded onto the core-armature guide unit, i.e., onto the core and onto the armature guide, by means of injection molding of a plastic. For this purpose, the core has a taper, arranged rotationally symmetrically around the coil longitudinal axis 32, in the form of an annular groove into which the coil body engages, so that the coil body and magnetic core are positively connected to one another.

DE 10 2007 028 910 B3 discloses a solenoid valve in which the core is directly injected in one manufacturing step during the injection molding of the bearing bush (armature guide), wherein the core has a circumferential groove into which the plastic of the bearing bush can settle during injection, so that the position of the core is additionally fixed axially. However, this design has the disadvantage that the relative position of the core to the bearing bush can no longer be changed during assembly of the solenoid valve.

CH 650 320 A5 describes a solenoid valve in which the stroke of the movable magnetic core is adjusted by axially displacing the fixed core by means of a threaded connection. In an alternative embodiment, the adjustment is carried out, for example, by means of an armature and by driving in the fixed core with precision.

A further electromagnetic directional control valve is known from DE 31 34 756 A1, in which the electromagnetically actuated upward movement of the valve piston occurs against the force of a spring.

The invention is based upon the object of making possible a more cost-effective production of the armature system or the solenoid valve.

The object is achieved according to the invention by the features of claims 1, 8, 10, and 11.

According to the invention, this object is achieved by an armature system for a solenoid valve, comprising a magnetic core, a magnetic armature, and a tubular armature guide for guiding the magnetic armature, wherein the armature guide is made of plastic, and the magnetic core is connected to the armature guide via a positive connection which is formed by a thermoplastic deformation of the armature guide.

The valve system according to the invention comprises a valve body and an armature system according to the invention mounted in the valve body, while the solenoid valve according to the invention has a solenoid coil in addition to the valve system according to the invention.

In the method according to the invention for producing a valve system, the following method steps are provided:
a magnetic armature is inserted together with an armature spring into an armature guide made of plastic,
the armature guide with the magnetic armature and the armature spring is then inserted into a valve body under compression of the armature spring,
the compression position of the armature spring, which corresponds to a desired opening pressure of the valve system, is adjusted by relative displacement of the armature guide and the valve body,
the armature guide and the valve body are fixed to one another in the compression position, which corresponds to the desired opening pressure of the valve system,
at one end, facing away from the valve body, of the armature guide, a magnetic core is inserted into the armature guide to a predetermined extent, and
the magnetic core and the armature guide are then connected to one another by local thermoplastic deformation of the armature guide.

A plastic material for the armature guide is significantly more cost-effective than the usual metal versions, in particular brass or stainless steel. In addition, thermoplastic deformation, which is carried out locally in the region of the positive connection between the magnetic core and the armature guide, has the additional advantage that the magnetic core can be adjusted to size during assembly by relative displacement of the magnetic core in the armature guide, which allows manufacturing tolerances, e.g., in the length of the armature guide, to be compensated for. A further advantage is that different requirements for the opening pressure or flow rate can be set using the same components, in particular the same springs.

Further embodiments of the invention are the subject matter of the dependent claims.

According to one embodiment of the invention, the magnetic core has, in the region of the positive connection with the armature guide, on its outer side that comes into contact with the armature guide, recesses for receiving plastic deformed by the thermoplastic deformation of the armature guide. These recesses can be formed, for example, by notches, grooves, in particular annular grooves, depressions, or the like. The magnetic core and the armature guide are thus positively connected to one another, and the magnetic core remains securely connected to the armature guide even under greater mechanical or thermal loads.

The armature guide is, expediently, made of a thermoplastic material, which may optionally also be fiber-reinforced, in particular glass fiber-reinforced.

According to the invention, an armature spring can be provided for resetting the magnetic armature. In a preferred embodiment, the armature spring is supported at one end on the magnetic armature and at the other end on an abutment. The choice of a suitable abutment depends primarily upon whether a normally closed or normally open solenoid valve is to be created. In the normally closed variant, the abutment must be arranged in such a way that the magnetic armature is pushed out of the armature guide by the armature spring—when installed in the solenoid valve—and the valve is thereby closed. This could be achieved by supporting the armature spring at one end on a shoulder formed inside the armature guide and at the other end on a flange-like extension of the magnetic armature.

In a further embodiment of the valve system according to the invention, the armature system has an armature spring for resetting the magnetic armature, and the valve body is designed such that the armature system is guided axially displaceably in the valve body under compression of the armature spring during assembly, and the armature guide and the valve body are fixed to one another in a compression position of the armature spring, which corresponds to a desired opening pressure of the solenoid valve, wherein the armature guide is preferably fixed in the valve body by means of laser beam welding. However, other connection techniques such as press, adhesive, insulation displacement, crimp, flange, or screw connections are also conceivable.

The thermoplastic deformation can be carried out in different ways; so, it is conceivable that
energy be input via the magnetic core, or
energy be input via the armature guide in the region of the positive connection to be established, or
separate heating of the magnetic core and armature guide and a subsequent joining be carried out.

According to a preferred embodiment of the invention, the thermoplastic deformation of the armature guide in the region of the magnetic core is carried out by heating the joint (region of the positive connection to be established) and subsequent forming.

Further embodiments of the invention are explained in more detail with reference to the following description of one exemplary embodiment and the drawings.

In the drawings:

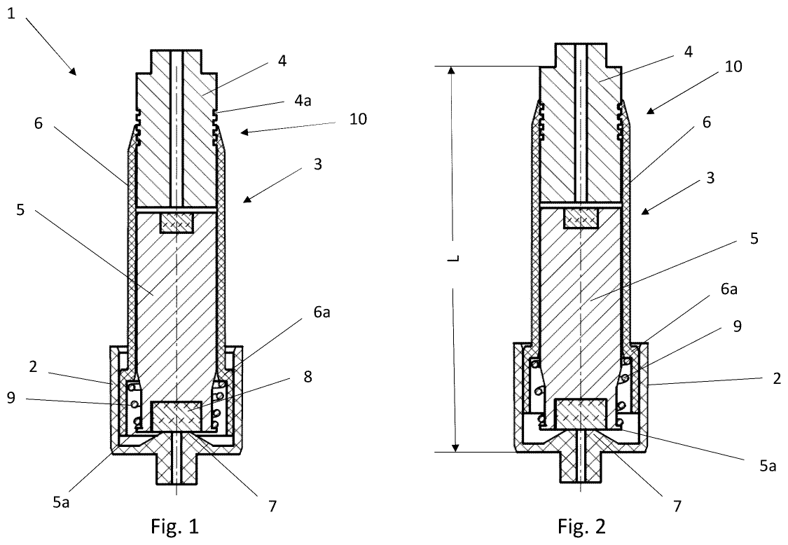

FIG. 1 shows a valve system according to the invention in a first axial relative position of valve body and armature guide,

FIG. 2 shows a valve system according to the invention in a second axial relative position of valve body and armature guide,

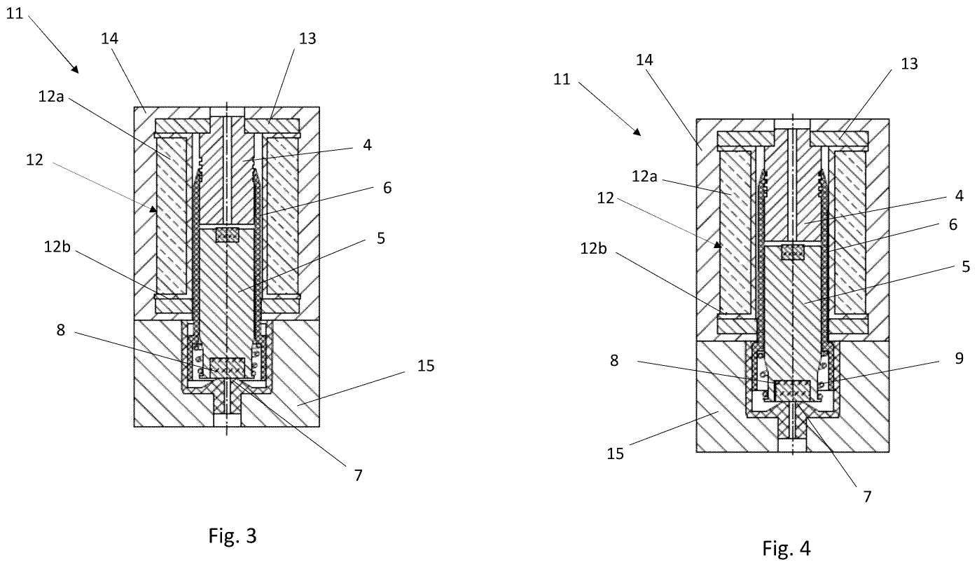

FIG. 3 shows a solenoid valve according to the invention with the valve system according to FIG. 1,

FIG. 4 shows a solenoid valve according to the invention with the valve system according to FIG. 2,

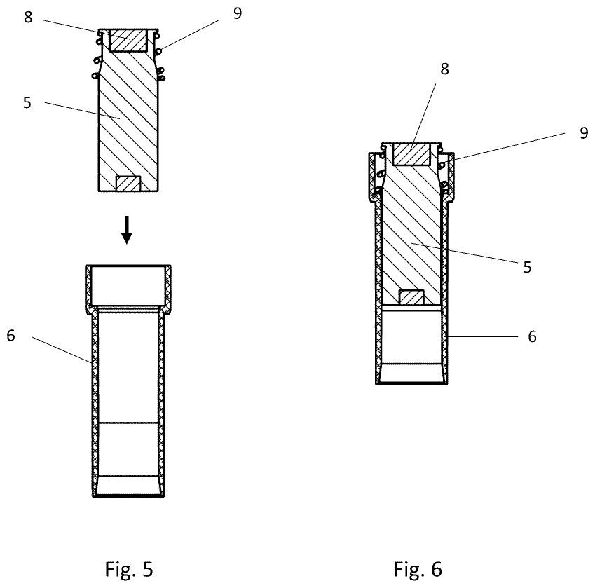

FIG. 5 shows a first method step in the production of the valve system, in which the magnetic armature and the armature guide are joined together,

FIG. 6 shows the state of the valve system after the first method step,

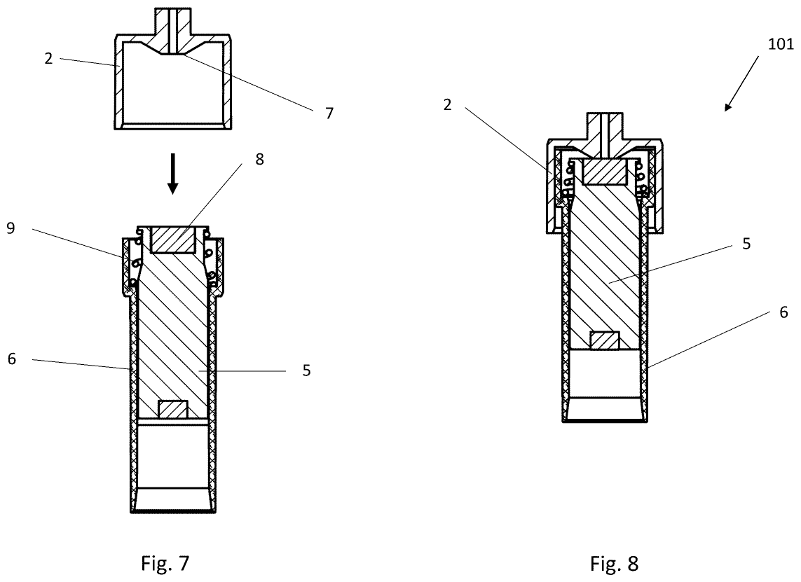

FIG. 7 shows a second method step in the production of the valve system, in which the valve body and the armature guide are joined together,

FIG. 8 shows the state of the valve system after the second method step,

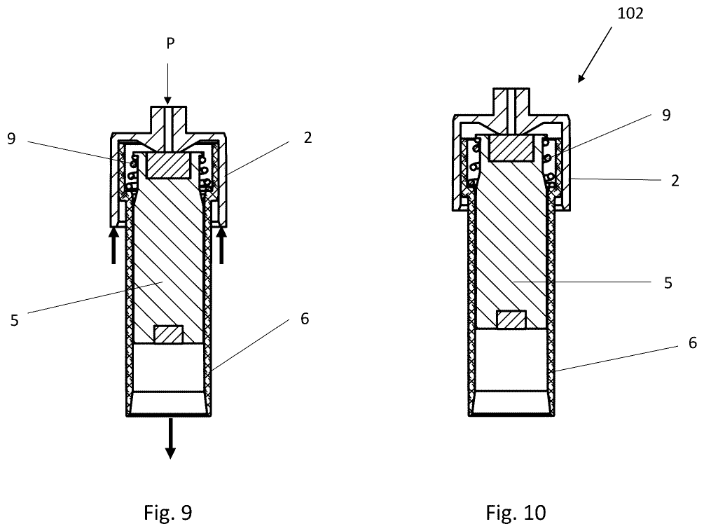

FIG. 9 shows a third method step in the production of the valve system, in which the compression position of the armature spring, which corresponds to a desired opening pressure of the solenoid valve, is adjusted by relative displacement of the armature guide and the valve body,

FIG. 10 shows the state of the valve system after the third method step,

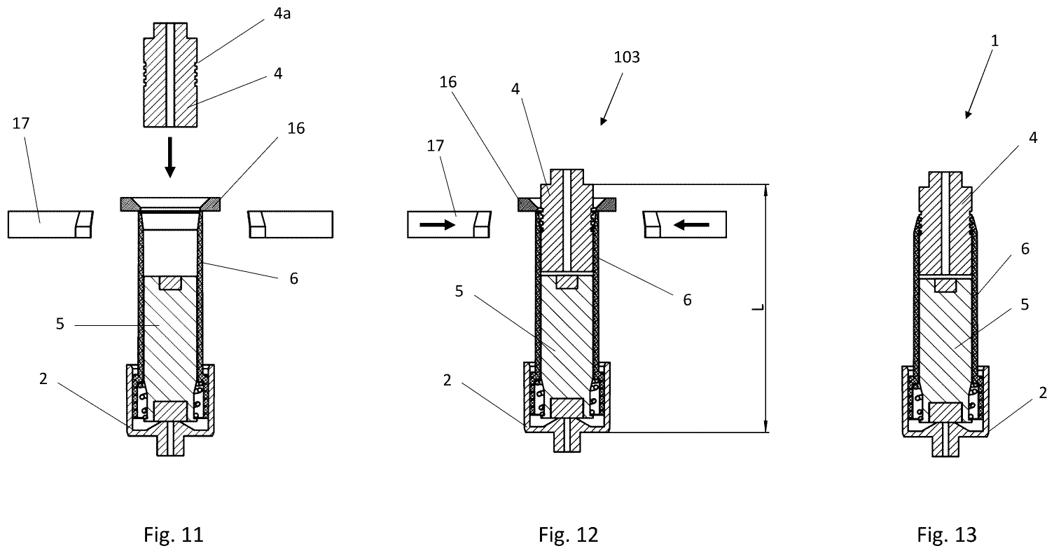

FIG. 11 shows a fourth method step in the production of the valve system, in which the magnetic core is inserted into the armature guide to a predetermined extent,

FIG. 12 shows a fifth method step in the production of the valve system, in which the magnetic core and the armature guide are connected to one another by local thermoplastic deformation of the armature guide, and

FIG. 13 shows the finished valve system.

The valve system 1 shown in FIG. 1 has a valve body 2 and an armature system 3 mounted in the valve body. The armature system 3 substantially consists of a magnetic core 4, a magnetic armature 5, and a tubular armature guide 6 for guiding the magnetic armature 5. The valve body has a valve seat 7 which interacts with a seat seal 8 arranged in the magnetic armature 5. In the illustrated exemplary embodiment, the magnetic armature 5 with its seat seal 8 is pressed onto the valve seat 7 by the pressure of an armature spring 9, which corresponds to the closed position of the valve system.

The armature spring 9 is supported at one end on a flange-like extension 5a of the magnetic armature 5 and at its other end on a shoulder 6a formed inside the armature guide 6. To form the shoulder 6a, the armature guide has a slightly larger outer and inner diameter at its end located in the valve body. The armature spring 9 is also conical, wherein the end with the larger diameter is supported on the shoulder 6a of the armature guide 6, and the end with the smaller diameter is supported on the flange-like extension 5a of the magnetic armature 5. However, cylindrical armature springs are also conceivable in the context of the invention. This is made possible, for example, by the fact that the flange-like extension 5a (armature plate) of the magnetic armature 5 is designed to be correspondingly larger.

The valve body 2 is designed such that the armature system 3 is guided axially displaceably in the valve body 2 under compression of the armature spring 9 during assembly. A relative displacement of the armature guide 6 and the valve body 2 changes the compression of the armature spring 3, and thus the pressure with which the seat seal 8 is pressed onto the valve seat 7. In this respect, a desired opening pressure of the valve system 1 can be set by the relative position of the armature guide 6 and the valve body 2. During assembly of the valve system 1, the armature guide 6 and the valve body 2 are fixed to one another in a compression position of the armature spring 9, which corresponds to a desired opening pressure of the valve system 1, wherein the fixation is preferably carried out by means of laser beam welding.

FIGS. 1 and 2 show two different relative positions of the armature guide 6 and the valve body 2. In the exemplary embodiment shown in FIG. 1, the armature guide 6 is pushed further into the valve body 2, whereby the armature spring 9 is compressed more strongly than in the exemplary embodiment shown in FIG. 2. With the exemplary embodiment shown in FIG. 1, a correspondingly stronger opening pressure is thus achieved.

According to the invention, the armature guide 6 is made of plastic, in particular a thermoplastic material. This allows a positive connection between the magnetic core 4 and the armature guide 6 by means of local thermoplastic deformation of the armature guide 6. For this purpose, the magnetic core 4 has, in the region 10 of the positive connection with the armature guide 6, on its outer side that comes into contact with the armature guide 6, recesses 4a for receiving plastic deformed by the thermoplastic deformation of the armature guide 6. These recesses 4a can be formed, for example, by notches, (annular) grooves, depressions, or the like.

During production of the valve system 1, it is now possible to insert the magnetic core 4 into the armature guide 6 to a predetermined extent in order to be able to set a given length L of the valve system 1 (FIG. 2), regardless of how far the armature guide 6 is inserted into the valve body. In this way, for a given length of the valve system, not only can different opening pressures or flow openings be set, but other manufacturing tolerances in the armature guide 6 and/or the armature spring 9 can also be compensated for.

FIG. 3 shows a solenoid valve 11 with the valve system 1 according to FIG. 1. In addition, a solenoid coil 12 with windings 12a and coil body 12b as well as a yoke 13 can be seen. The solenoid coil 12 and yoke 13 are housed in a solenoid coil casing 14. The valve body 2 is also arranged within a valve housing 15. Both the solenoid coil casing 14 and the valve housing 15 are preferably made of injection-molded plastic.

The solenoid valve shown in FIG. 4 differs only in that the valve system 1 according to FIG. 2 is used, which requires a lower opening pressure with the same armature spring 9, but otherwise has the same external dimensions.

By actuating the solenoid coil 12, the magnetic armature 5 is pulled against the magnetic core 4 under further compression of the armature spring 5, so that the seat seal 8 is lifted off the valve seat 9, and the valve is thus opened. If the current supply to the solenoid coil 12 is interrupted again, the armature spring 9 returns the magnetic armature 5 to the closed position, in which the seat seal 8 is pressed onto the valve seat 7 with the pressure set by the (pre-)compression of the armature spring 9.

The individual steps in the production of the valve system 1 are explained in more detail with reference to FIGS. 5 to 13.

In the first method step according to FIG. 5, the magnetic armature 5 is inserted together with the armature spring 9 into the armature guide 6, so that the first intermediate product 100 according to FIG. 6 is obtained.

In the second method step according to FIG. 7, the armature guide 6 is inserted into the valve body 2 under compression of the armature spring 9, so that the second intermediate product 101 according to FIG. 8 is obtained, wherein the minimum installation space (the armature guide 6 is completely pressed into the valve body 2) with maximum preload of the armature spring 9 is shown here.

In the third method step (FIG. 9), the compression position of the armature spring 9, which corresponds to a desired opening pressure P of the valve system 1, is adjusted by relative displacement of the armature guide 6 and the valve body 2. For this purpose, for example, the valve body 2 is first fixed, and the armature guide 6 is completely inserted into the valve body 2 so that the armature spring is maximally compressed. A pressure P is then applied to the valve seat, which is to correspond to the desired opening pressure. The armature guide 6 is then slowly pulled out of the valve body 2 until the pressure of the armature spring 9 is no longer sufficient to hold the seat seal 8 on the valve seat 7. The resulting relative position of valve body 2 and armature guide 6 represents the compression position of the armature spring 9, which corresponds to the desired opening pressure P of the valve system 1. The armature guide 6 and the valve body 2 are then fixed to one another in this relative position—for example, by means of laser beam welding. The resulting third intermediate product 102 is shown in FIG. 10.

In the fourth method step, the fourth intermediate product 103 is obtained by inserting the magnetic core 4 according to FIG. 11 into the armature guide 6 up to a predetermined extent (FIG. 12). The predetermined extent is, for example, the length L, measured between a shoulder of the magnetic core 4 and a shoulder of the valve body 2 according to FIG. 12. However, the total length of the valve system 1 could also be used for this purpose.

In the fifth and final method step, the magnetic armature 4 and the armature guide 6 are connected to one other by local thermoplastic deformation of the armature guide 6. For this purpose, the armature guide 6 can be heated, for example, via a heat source 16 in the region 10 of the positive connection, and then formed using a forming tool 17 (FIG. 12).

After this method step, the valve system 1 is completed (FIG. 13).

Of course, the valve system 1 also has the usual seals, which have not been explicitly mentioned in the above description. For example, the magnetic core 4 is inserted with an O-ring seal into the armature guide 6. The end of the magnetic core 6 protruding from the armature guide 6 is also provided with a further seal. Furthermore, the valve body 2 is fitted with seals before it is installed in the valve housing 15.

1. An armature system for a solenoid valve with a magnetic core, a magnetic armature, and a tubular armature guide for guiding the magnetic armature, wherein the armature guide is made of plastic, and the magnetic core is connected to the armature guide via a positive connection,
characterized in that the positive connection is formed by a local thermoplastic deformation of the armature guide.

2. The armature system according to claim 1, characterized in that the magnetic core, in the region of the positive connection with the armature guide, on its outer side that comes into contact with the armature guide, is provided with recesses for receiving plastic deformed by the thermoplastic deformation of the armature guide.

3. The armature system according to claim 2, characterized in that the recesses are formed by notches, grooves, depressions, or the like.

4. The armature system according to claim 1, characterized in that the armature guide consists of a thermoplastic material.

5. The armature system according to claim 1, characterized in that an armature spring is provided for resetting the magnetic armature.

6. The armature system according to claim 5, characterized in that the armature spring is supported at one end on the magnetic armature and at the other end on an abutment.

7. The armature system according to claim 6, characterized in that the armature spring is supported at one end on a flange-like extension of the magnetic armature, and the abutment is formed by a shoulder formed inside the armature guide.

8. A valve system with a valve body and an armature system according to one or more of claim 1 mounted in the valve body.

9. The valve system according to claim 8, characterized in that
the armature system has an armature spring for resetting the magnetic armature,
the valve body is designed such that the armature system is guided axially displaceably in the valve body under compression of the armature spring during assembly, and
the armature guide and the valve body are fixed to one another in a compression position of the armature spring, which corresponds to a desired opening pressure of the valve system.

10. A solenoid valve with a solenoid coil and a valve system according to claim 8.

11. A method for producing a valve system, characterized in that
a magnetic armature together with an armature spring is inserted into an armature guide made of plastic,
the armature guide with the magnetic armature and the armature spring is then inserted into a valve body under compression of the armature spring,
the compression position of the armature spring, which corresponds to a desired opening pressure of the valve system, is adjusted by relative displacement of the armature guide and the valve body,
the armature guide and the valve body are fixed to one another in the compression position, which corresponds to the desired opening pressure of the valve system,
at one end, facing away from the valve body, of the armature guide, a magnetic core is inserted into the armature guide to a predetermined extent, and
finally, the magnetic core and the armature guide are connected to one another by local thermoplastic deformation of the armature guide.

12. The method according to claim 10, characterized in that the thermoplastic deformation is carried out by heating a joint and subsequent forming.

13. The method according to claim 10, characterized in that the thermoplastic deformation is carried out by
an energy input via the magnetic core or
an energy input via the armature guide in the region of the positive connection to be established or
separate heating of the magnetic core and armature guide and subsequent joining.

14. The method according to claim 11, characterized in that the fixation of the armature guide in the valve body is carried out by means of laser beam welding.
